(19) United States
(12) Patent Application Publication
(10) Pub. No.: US 2025/0036149 A1
(43) Pub. Date: Jan. 30, 2025

(54) SEARCH ASSISTANCE DEVICE, SEARCH ASSISTANCE SYSTEM, SEARCH ASSISTANCE METHOD, AND COMPUTER-READABLE STORAGE MEDIUM

(71) Applicant: NEC Corporation, Minato-ku, Tokyo (JP)

(72) Inventors: Remi TANAKA, Tokyo (JP); Takeshi SHOUTA, Tokyo (JP); Hiroyuki KAKINUMA, Tokyo (JP); Tomoyuki MUTO, Tokyo (JP)

(73) Assignee: NEC Corporation, Minato-ku, Tokyo (JP)

(21) Appl. No.: 18/716,573

(22) PCT Filed: Dec. 17, 2021
(86) PCT No.: PCT/JP2021/046750

§ 371 Date: Jun. 5, 2024

(51) Int. Cl. G05D 1/86; G05D 1/24; G05D 109/20; G05D 111/10; G06Q 40/08

(52) U.S. Cl. CPC G05D 1/86; G05D 1/24; G06Q 40/08; G05D 2109/20; G05D 2111/10

(57) ABSTRACT

One purpose of the present invention is to provide a search assistance device, etc., capable of assisting in searching for a mobile object. A search assistance device according to one aspect of the present disclosure comprises an acquisition means that acquires abnormality notification information transmitted from a mobile object in which an abnormality has occurred among a plurality of mobile objects, a specification means that specifies an attribute of a search target, which is the mobile object that has transmitted the abnormality notification information, on the basis of attribute information that relates to the attributes of mobile objects and is stored in a storage means; and a calculation means that calculates a search priority level according to the attribute of the search target on the basis of a predetermined rule.

### TECHNICAL FIELD

The present disclosure relates to a technique for assisting search for a mobile object.

### BACKGROUND ART

There is a need to cause a mobile object flying in an unmanned manner to fly in a densely populated area such as an urban area. At that time, it is required to safely operate the mobile object.

Cited Document 1 discloses a technique related to safe operation of a mobile object. The Cited Document 1 discloses a technique for controlling a fall position of an unmanned flight vehicle that is falling to be shifted to avoid collision with an object. Specifically, the control device estimates the fall position from the image captured by the unmanned flight vehicle that is falling. Then, the user shifts the fall position by controlling the unmanned flight vehicle based on the estimated fall position.

### CITATION LIST

### Patent Literature

PTL 1: WO 2021/039387 A1

### SUMMARY OF INVENTION

### Technical Problem

There is a possibility that the mobile object falls due to runout of charge, failure, or the like of the mobile object. When a mobile object is used in fields such as transportation and distribution, a large number of mobile objects fly in an airspace. In such a case, there is a possibility that a plurality of mobile objects fall.

In a case where a large number of mobile objects fly in the airspace, it is conceivable that each mobile object is automatically controlled or the flying place is different. That is, the situations of the fallen mobile objects are different from each other. The fallen mobile object needs to be searched quickly, but there is also a mobile object that needs to be searched preferentially depending on the situation.

The present disclosure has been made in view of the above problems, and one of the objects is to provide a search assistance device and the like capable of assisting the search for a mobile object.

### Solution to Problem

A search assistance device according to one aspect of the present disclosure includes an acquisition means that acquires abnormality notification information transmitted from a mobile object in which an abnormality has occurred among a plurality of mobile objects, a specification means that specifies an attribute of a search target, which is a mobile object that has transmitted the abnormality notification information, based on attribute information related to attributes of mobile objects stored in a storage means, and a calculation means that calculates a priority of a search according to the attribute of the search target based on a predetermined rule defined in advance.

A search assistance system according to one aspect of the present disclosure includes a mobile object including a position information acquisition means that acquires position information an abnormality detection means that detects abnormality, and a transmission means that transmits abnormality notification information when the abnormality is detected, and a search assistance device including an acquisition means that acquires the abnormality notification information transmitted from the mobile object in which the abnormality has occurred among the plurality of mobile objects, a specification means that specifies an attribute of a search target that has transmitted the abnormality notification information of the mobile objects based on attribute information related to attributes of the mobile objects stored in a storage means, and a calculation means that calculates a priority of a search according to the attribute of the search target based on a predetermined rule defined in advance.

A search assistance method according to one aspect of the present disclosure includes acquiring abnormality notification information transmitted from a mobile object in which an abnormality has occurred among a plurality of mobile objects, specifying an attribute of a search target, which is a mobile object that has transmitted the abnormality notification information, based on attribute information related to attributes of mobile objects stored in a storage means, and calculating a priority of a search according to the attribute of the search target based on a predetermined rule defined in advance.

A computer-readable storage medium according to one aspect of the present disclosure that stores a program for causing a computer to execute a process of acquiring abnormality notification information transmitted from a mobile object in which an abnormality has occurred among a plurality of mobile objects, a process of specifying an attribute of a search target, which is a mobile object that has transmitted the abnormality notification information, based on attribute information related to attributes of mobile objects stored in a storage means, and a process of calculating a priority of a search according to the attribute of the search target based on a predetermined rule defined in advance.

### Advantageous Effects of Invention

According to the present disclosure, the search for a mobile object can be assisted.

### BRIEF DESCRIPTION OF DRAWINGS

FIG. 1 is a diagram schematically illustrating an example of a configuration of a search assistance system including a search assistance device according to a first example embodiment of the present disclosure.

FIG. 2 is a block diagram illustrating an example of a search assistance device according to the first example embodiment of the present disclosure.

FIG. 3 is a flowchart describing an example of an operation of the search assistance device according to the first example embodiment of the present disclosure.

FIG. 4 is a diagram schematically illustrating an example of a configuration of a search assistance system according to a second example embodiment of the present disclosure.

FIG. 5 is a block diagram illustrating an example of a functional configuration of the search assistance system according to the second example embodiment of the present disclosure.

FIG. 6 is a diagram illustrating an example of mobile object information according to the second example embodiment of the present disclosure.

FIG. 7 is a diagram illustrating an example of a flight plan according to the second example embodiment of the present disclosure.

FIG. 8A is a diagram illustrating a first example of rule information according to the second example embodiment of the present disclosure.

FIG. 8B is a diagram illustrating a second example of rule information according to the second example embodiment of the present disclosure.

FIG. 8C is a diagram illustrating a third example of rule information according to the second example embodiment of the present disclosure.

FIG. 9 is a diagram illustrating an example of search target management information according to the second example embodiment of the present disclosure.

FIG. 10 is a sequence diagram illustrating an example of an operation of the search assistance system according to the second example embodiment of the present disclosure.

FIG. 11 is a sequence diagram illustrating an example of an operation of the search assistance system according to the second example embodiment of the present disclosure.

FIG. 12 is a block diagram illustrating an example of a functional configuration of a search assistance system according to a third example embodiment of the present disclosure.

FIG. 13 is a sequence diagram illustrating an example of an operation of the search assistance system according to the third example embodiment of the present disclosure.

FIG. 14 is a block diagram illustrating an example of a functional configuration of a search assistance system according to a fourth example embodiment of the present disclosure.

FIG. 15 is a sequence diagram illustrating an example of an operation of the search assistance system according to the fourth example embodiment of the present disclosure.

FIG. 16 is a block diagram illustrating an example of a functional configuration of a search assistance system according to a fifth example embodiment of the present disclosure.

FIG. 17 is a diagram illustrating an example of a situation in which a mobile object reads control information according to the fifth example embodiment of the present disclosure.

FIG. 18 is a flowchart describing an example of an operation of the mobile object according to the fifth example embodiment of the present disclosure.

FIG. 19 is a block diagram illustrating an example of a hardware configuration of a computer device that implements the search assistance system according to the first, second, third, fourth, and fifth example embodiments of the present disclosure.

### EXAMPLE EMBODIMENT

Hereinafter, example embodiments of the present disclosure will be described with reference to the drawings.

### First Example Embodiment

An outline of a search assistance device of the present disclosure will be described.

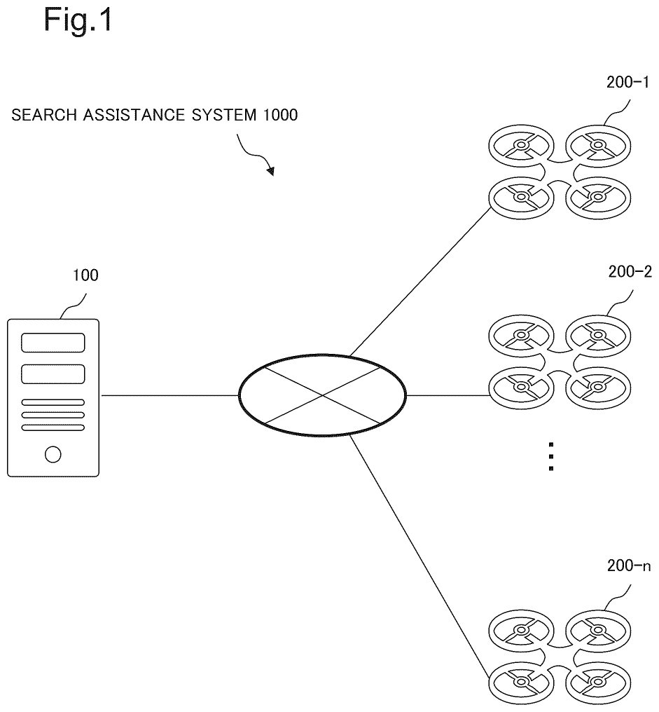

FIG. 1 is a diagram schematically illustrating an example of a configuration of a search assistance system including a search assistance device. As illustrated in FIG. 1, a search assistance system 1000 includes a search assistance device 100 and mobile objects 200-1, 200-2, . . . , 200-n (n is a natural number equal to or greater than 1). Here, in a case where the mobile objects 200-1, 200-2, . . . , and 200-n are not distinguished from one another, the mobile objects 200-1, 200-2, . . . , and 200-n are referred to as a mobile object 200. The search assistance device 100 and the mobile object 200 are communicably connected via a wireless or wired network.

In the present disclosure, the mobile object is, for example, an unmanned aerial vehicle. The mobile object may be, for example, an airplane, a helicopter, an airship, a multicopter (also called multi-rotor helicopter, or multi-rotor, etc.), or the like. The unmanned aerial vehicles may also be referred to as UAVs (Unmanned Aerial Vehicles), small unmanned machines or drones. In the present disclosure, an example in which the mobile object is an unmanned mobile object will be described, but other examples are not to be excluded. The mobile object may be, for example, a manned aerial vehicle or a vehicle traveling on the ground.

The mobile object 200 transmits transmitted information. The transmitted information includes position information and identification information of the mobile object 200. The transmitted information may further include other information such as information indicating a time when the mobile object 200 transmitted the transmitted information. The mobile object 200 may acquire the position information of the own machine by a positioning signal receiving device mounted on the mobile object 200. The positioning signal receiving device, for example, receives a signal transmitted from a positioning satellite of a global navigation satellite system (GNSS) such as a global positioning system (GPS) satellite, and acquires position information indicating the position of the own machine based on the received signal. The position information may include information indicating the altitude of the own machine. The altitude is acquired by, for example, an altimeter mounted on the mobile object 200. The transmitted information may be transmitted by, for example, a remote identification (ID) device mounted on the mobile object. The mobile object 200 may periodically transmit the transmitted information. For example, the mobile object 200 may transmit the transmitted information once per second.

In addition, the mobile object 200 transmits abnormality notification information. The abnormality notification information is information transmitted to the mobile object 200 in a case where abnormality such as runout of battery charge, failure, or dropping occurred. The abnormality notification information includes identification information of the mobile object 200. The abnormality notification information may further include other information such as information indicating the time when the mobile object 200 transmitted the mobile object notification information.

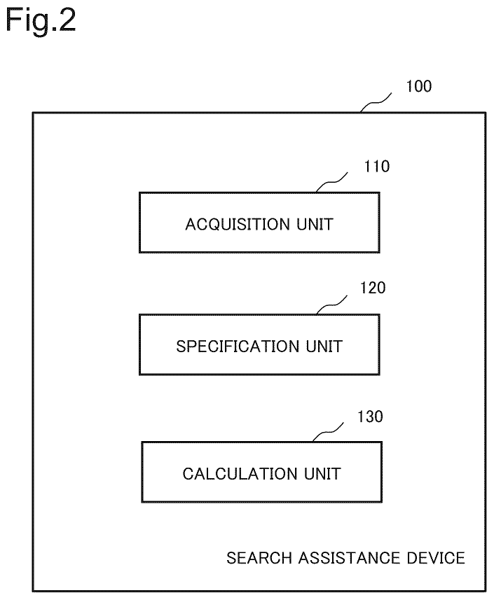

FIG. 2 is a block diagram illustrating an example of a functional configuration of the search assistance device 100 according to the first example embodiment. As illustrated in FIG. 2, the search assistance device 100 includes an acquisition unit 110, a specification unit 120, and a calculation unit 130.

The acquisition unit 110 acquires transmitted information and abnormality notification information from the mobile object 200. For example, the acquisition unit 110 acquires the transmitted information from the mobile object 200 as needed. At this time, for example, the acquisition unit 110 stores the identification information and the position information in the storage means in association with each other. Then, when an abnormality occurs in at least one of the plurality of mobile objects 200, the acquisition unit 110 acquires the abnormality notification information from the mobile object 200 in which the abnormality has occurred. In this manner, the acquisition unit 110 acquires the abnormality notification information transmitted from the mobile object in which the abnormality has occurred among the plurality of mobile objects. The acquisition unit 110 is an example of an acquisition means.

The specification unit 120 specifies the attribute of the mobile object that transmitted the abnormality notification information. Here, the mobile object that transmitted the abnormality notification information is also referred to as a search target. The specification unit 120 specifies the attribute of the search target from the attribute information stored in the storage device (not illustrated). The storage device is a device that stores various types of information. The storage device may be provided in the search assistance device 100 or may be an external device capable of communicating with the search assistance device 100. The storage device is an example of a storage means. The attribute information is information regarding an attribute of the mobile object 200. The attribute information is associated with identification information of the mobile object 200. The attribute includes, for example, position information of the mobile object 200, information regarding a load of the mobile object 200, information indicating whether an owner of the mobile object 200 has insurance, and the like. For example, the position information of the mobile object 200 may be updated as needed based on the transmitted information acquired by the acquisition unit 110. Furthermore, the information regarding the load of the mobile object 200 and the information indicating whether the owner of the mobile object 200 has insurance are, for example, information input in advance by the owner of the mobile object 200. The attribute is not limited to this example. The attribute may include, for example, information regarding a model such as a size and a moving speed of the mobile object 200, and information regarding an owner such as a name, an address, and a contact of the owner.

For example, the specification unit 120 specifies the attribute of the search target associated with the identification information of the search target from the attribute information. In this manner, the specification unit 120 specifies the attribute of the search target that is the mobile object that transmitted the abnormality notification information based on the attribute information regarding the attribute of the mobile object stored in the storage means. The specification unit 120 is an example of a specification means.

The calculation unit 130 calculates a search priority for the mobile object 200 that transmitted the abnormality notification information. The calculation unit 130 calculates the priority corresponding to the attribute specified by the specification unit 120 based on a predetermined rule. The predetermined rule may indicate, for example, a degree to be prioritized defined in advance according to the content of the attribute. For example, in a case where the mobile object 200 fell into an urban area, the possibility that an accident caused by the fall will occur is high as compared with a case where the mobile object falls into a river. Therefore, in a case where the mobile object 200 in which the abnormality has occurred is located in an urban area (or in the sky above the urban area), it is conceivable to perform the search more quickly than in a case where the mobile object is located in a river (or in the sky above the river). Therefore, the predetermined rule includes, for example, a rule that, in a case where the latest position information of the search target indicates an urban area, priority is increased as compared with a case where the position information indicates a river. In addition, for example, assume that there is a load on the mobile object 200. In this case, the predetermined rule may include, for example, a rule of increasing the priority of the search target when the load of the search target is emergency relief supplies at the time of disaster or the like. The predetermined rule is not limited to this example, and may include a rule for priority calculation according to contents of various types of attributes. In addition, the predetermined rule may be information in which a numerical value is defined for each content of various types of attributes. For example, the calculation unit 130 may calculate a value obtained by adding numerical values corresponding to the contents of various types of attributes of the search target as the priority. In this manner, the calculation unit 130 calculates the priority of the search corresponding to the attribute of the search target based on the predetermined rule defined in advance. The calculation unit 130 is an example of a calculation means.

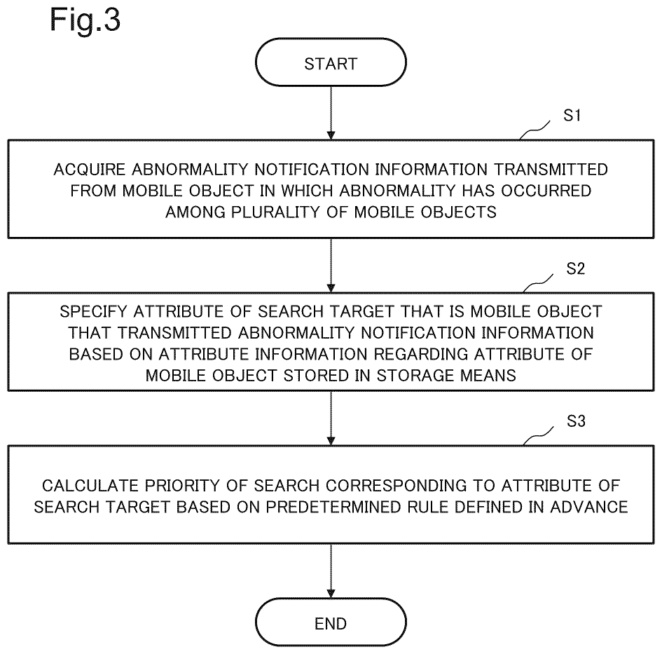

Next, an example of the operation of the search assistance device 100 will be described with reference to FIG. 3. In the present disclosure, each step in the flowchart is represented using a number assigned to each step, such as “S1”.

FIG. 3 is a flowchart describing an example of the operation of the search assistance device 100. The acquisition unit 110 acquires the abnormality notification information transmitted from the mobile object in which the abnormality has occurred among the plurality of mobile objects (S1). The specification unit 120 specifies the attribute of the search target that is the mobile object that transmitted the abnormality notification information based on the attribute information regarding the attribute of the mobile object stored in the storage means (S2). Then, the calculation unit 130 calculates the priority of the search corresponding to the attribute of the search target based on the predetermined rule defined in advance (S3).

As described above, the search assistance device 100 according to the first example embodiment acquires the abnormality notification information transmitted from the mobile object in which the abnormality has occurred among the plurality of mobile objects. In addition, the search assistance device 100 specifies the attribute of the search target that is the mobile object that transmitted the abnormality notification information based on the attribute information regarding the attribute of the mobile object stored in the storage means. Then, the search assistance device 100 calculates a priority of the search corresponding to the attribute of the search target based on a predetermined rule defined in advance. As a result, for example, in a case where an abnormality has occurred in a plurality of mobile objects, the search assistance device 100 can present which mobile object should be preferentially searched for by providing the search priority to the observer of the mobile object. Therefore, the observer of the mobile object can quickly start searching for the mobile object based on the priority. That is, the search assistance device 100 according to the first example embodiment can assist a search for a mobile object.

### Second Example Embodiment

Next, a search assistance system including a search assistance device according to a second example embodiment will be described. In a second example embodiment, the search assistance device 100 described in the first example embodiment will be described in more detail. Description of contents redundant with the contents described in the first example embodiment will be partially omitted.

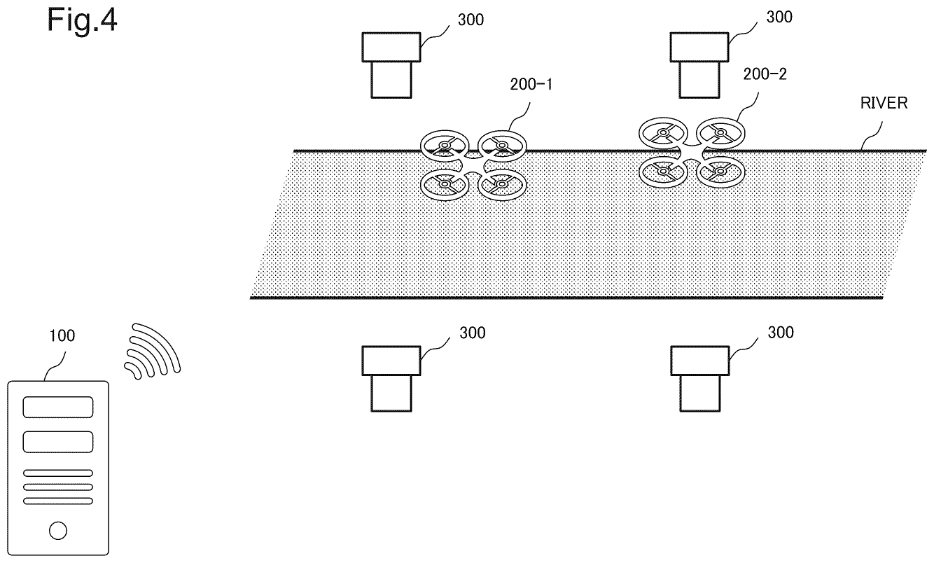

FIG. 4 is a diagram schematically illustrating an example of a configuration of a search assistance system 1000. The mobile object 200 moves in a specific area. Here, a specific area formed in the air for passage of the mobile object 200 is also referred to as a corridor. The corridor serves as a road in the mobile object 200. Here, the corridor may include a dedicated airspace for passage of the mobile object 200, in which a service for allowing the mobile object 200 to pass safely is provided. Such a dedicated airspace, particularly an airspace specialized for drones, may be referred to as a drone highway. In the example of FIG. 4, a mobile object 200-1 and a mobile object 200-2 pass through a corridor formed above a river. In addition, the observation device 300 may be arranged at the periphery of the corridor. The observation device 300 is a device capable of communicating with the search assistance device 100 and the mobile object 200. The observation device 300 and the mobile object 200 communicate with each other by a communication method such as Bluetooth (registered trademark). The communication method is not limited to this example, and may be a known method. The observation device 300 receives transmitted information and abnormality notification information transmitted from a mobile object 200 passing through a corridor or an area at the periphery of the corridor. The observation device 300 transmits the transmitted information and the abnormality notification information to the search assistance device 100. In this manner, the search assistance device 100 acquires information transmitted from the mobile object 200. The user of the search assistance device 100 is, for example, an administrator of the corridor. The user of the search assistance device 100 starts a search, for example, based on the information provided by the search assistance device 100.

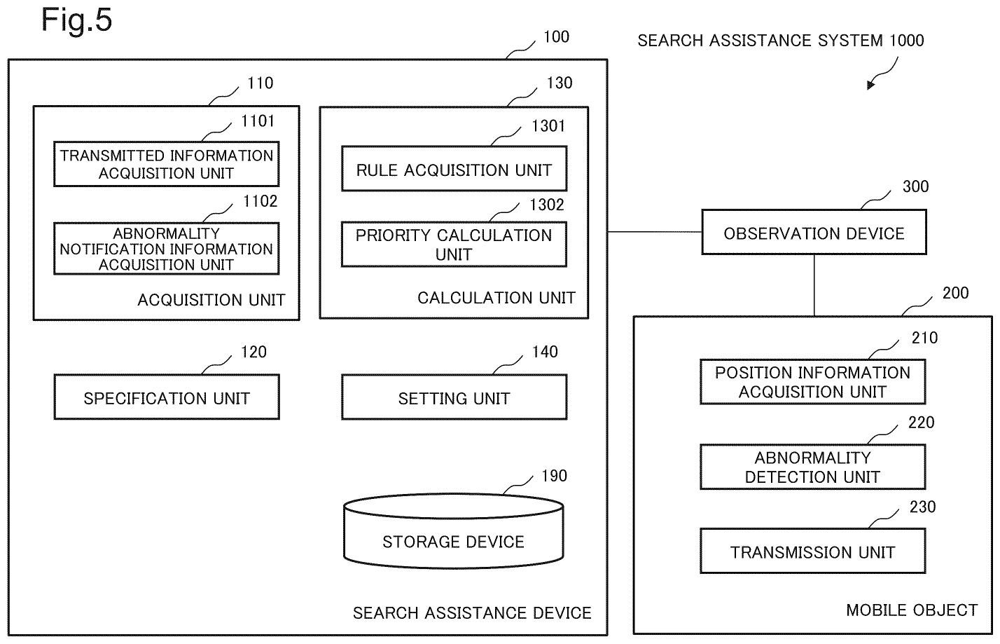

FIG. 5 is a block diagram illustrating an example of a functional configuration of the search assistance system 1000 according to the second example embodiment. As illustrated in FIG. 5, the search assistance system 1000 includes a search assistance device 100, a mobile object 200, and an observation device 300.

### [Details of Mobile Object 200]

The mobile object 200 includes a position information acquisition unit 210, an abnormality detection unit 220, and a transmission unit 230. The position information acquisition unit 210 acquires position information of the own machine. The position information acquisition unit 210 has, for example, the function of the positioning signal receiving device described above. The position information acquisition unit 210 periodically acquires position information. The position information acquisition unit 210 is an example of a position information acquisition means.

The abnormality detection unit 220 detects an abnormality. For example, the abnormality detection unit 220 detects an abnormality when the remaining capacity of the battery becomes less than a predetermined value. Furthermore, the abnormality detection unit 220 may detect an application of an impact on the own machine as an abnormality. For example, the abnormality detection unit 220 detects an impact caused by falling or hitting an object such as a building or an animal. In addition, the abnormality detection unit 220 may detect the flooding of the inside of the mobile object 200 as an abnormality. In this case, for example, a mechanism that conducts electricity by getting wet with water is provided inside the mobile object 200. Therefore, when the mobile object 200 is flooded, the mechanism is energized. The abnormality detection unit 220 may detect flooding by energization. The abnormality detection unit 220 is an example of an abnormality detection means.

The transmission unit 230 transmits transmitted information. The transmitted information includes the position information acquired by the position information acquisition unit 210 and the identification information of the own machine. The transmission unit 230 may periodically transmit the transmitted information. In addition, when an abnormality is detected by the abnormality detection unit 220, the transmission unit 230 transmits abnormality notification information. Here, in a case where a mechanism that conducts electricity by getting wet with water is provided inside the mobile object 200, the transmission unit 230 may include a function of transmitting abnormality notification information when electricity is conducted by flooding. The abnormality notification information includes identification information of the own machine. The abnormality notification information may further include information indicating the type of abnormality detected by the abnormality detection unit 220 and position information when the abnormality is detected. The transmission unit 230 is an example of a transmission means.

### [Details of Search Assistance Device 100]

The search assistance device 100 includes an acquisition unit 110, a specification unit 120, and a calculation unit 130. In addition, the search assistance device 100 may further include a setting unit 140. Furthermore, the search assistance device 100 may include a storage device 190. The storage device 190 is an example of the storage means described above. That is, the storage device 190 may be an external device capable of communicating with the search assistance device 100.

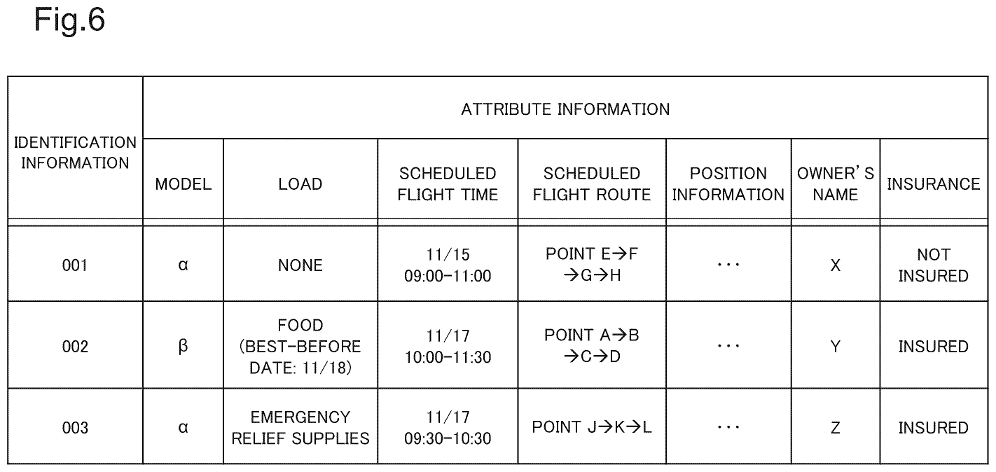

The storage device 190 includes mobile object information. The mobile object information is information in which identification information of the mobile object 200 and attribute information are associated with each other. FIG. 6 is a diagram illustrating an example of mobile object information. In the example of FIG. 6, items of “model”, “load”, “scheduled flight time”, “scheduled flight route”, “position information”, “owner's name”, and “whether insured in insurance” are set as the attribute information. For example, the record in the first line indicates that the mobile object having the identification information “001” has a model “a”, has no load, and flies to point E, point F, point G, and point H in this order from 9:00 to 11:00 on November 15. Here, the item “position information” indicates at least a position where the mobile object having the identification information “001” is currently flying. The item “position information” may indicate a path of a position where the mobile object has flown by the current time. The item “position information” may be updated, for example, in response to acquisition of the position information by the acquisition unit 110. Furthermore, the record in the first line indicates that the owner's name of the mobile object having the identification information “001” is “X”, and the owner is “not insured” to the insurance. The insurance may be, for example, a service that preferentially searches for a mobile object. In a case where the mobile object of the owner who has insurance is a search target, for example, the calculation unit 130 performs a process of giving priority.

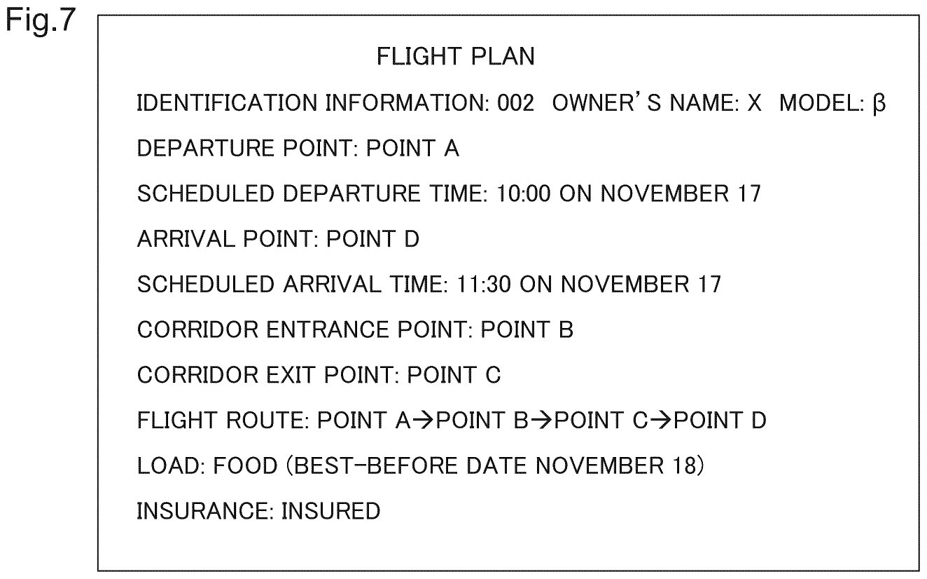

The mobile object information is stored in the storage device 190. At this time, the mobile object information is generated, for example, according to a flight plan input in advance by the owner. The flight plan is information submitted by the owner before the mobile object 200 flies. The flight plan is, for example, pre-filled by the owner and submitted to the administrator of the corridor. FIG. 7 is a diagram illustrating an example of a flight plan. The flight plan includes information such as a place and time at which the mobile object 200 is scheduled to fly, in addition to the identification information of the mobile object 200. In the example of FIG. 7, a departure point, a scheduled departure time, an arrival point, a scheduled arrival time, a corridor entrance point, a corridor exit point, and a flight route are indicated in the flight plan. Furthermore, the flight plan may also include information regarding whether the owner has insurance and the load of the mobile object 200. The mobile object information is generated in advance based on such a flight plan. At this time, the search assistance device 100 may have a function of receiving an input of a flight plan or a function of generating mobile object information.

The acquisition unit 110 includes a transmitted information acquisition unit 1101 and an abnormality notification information acquisition unit 1102. The transmitted information acquisition unit 1101 acquires the transmitted information transmitted by the mobile object 200 via the observation device 300. The transmitted information acquisition unit 1101 stores the acquired position information in the storage device 190 in association with the identification information. At this time, for example, the transmitted information acquisition unit 1101 may update the item of the position information of the mobile object information. The abnormality notification information acquisition unit 1102 acquires the abnormality notification information transmitted by the mobile object 200 via the observation device 300.

The specification unit 120 specifies the attribute of the search target that is the mobile object that transmitted the abnormality notification information. For example, when the abnormality notification information is acquired by the abnormality notification information acquisition unit 1102, the specification unit 120 refers to the identification information included in the abnormality notification information. Then, the specification unit 120 specifies an attribute associated with the same identification information as the referenced identification information from the mobile object information. For example, assume that the identification information indicated in the abnormality notification information is “002”. Here, in a case where the mobile object information illustrated in the example of FIG. 6 is stored in the storage device 190, the specification unit 120 specifies the attribute indicated in the attribute information of the record in the second line of the mobile object information. At this time, the specification unit 120 may specify only the attribute related to the calculation of priority. For example, in a case where the load, the position information, and the insurance are used for calculating the priority among the attributes by the calculation unit 130 to be described later, the specification unit 120 may specify only the information indicated in the items of “load”, “position information”, and “insurance” among the attribute information.

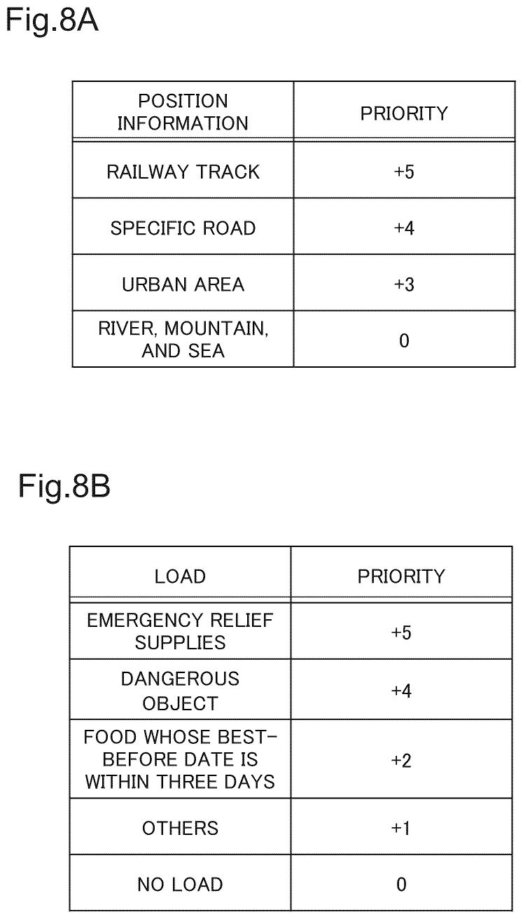

The calculation unit 130 includes a rule acquisition unit 1301 and a priority calculation unit 1302. The rule acquisition unit 1301 acquires rule information. The priority calculation unit 1302 calculates the priority of the search target based on the rule information. The rule information indicates a predetermined rule defined in advance. More specifically, the rule information is information indicating a degree to be prioritized, which is defined in advance according to the content of the attribute. The rule information, for example, is stored in the storage device 190. The rule information will be described with reference to FIGS. 8A, 8B, and 8C.

FIG. 8A is a diagram illustrating a first example of the rule information. In the example of FIG. 8A, items “position information” and “priority” are set in the rule information. That is, the rule information includes a value indicating the priority corresponding to the place indicated by the position information. For example, a record in the first line indicates that the priority is increased by five in a case where the position information of the search target indicates a place of a railway track. For example, when a search target falls on a railway track, a train running on the railway track collides with the search target, and an accident may occur. Therefore, in a case where the position information of the search target indicates a place of a railway track, the priority calculation unit 1302 increases the priority. In this manner, the priority calculation unit 1302 calculates the priority according to the position information of the search target. The priority calculation unit 1302 may specify a place indicated in the position information of the search target based on, for example, the position information of the search target and the map information. At this time, the map information may be stored in the storage device 190 or may be acquired through the Internet.

FIG. 8B is a diagram illustrating a second example of the rule information. In the example of FIG. 8B, items “load” and “priority” are set in the rule information. That is, the rule information includes a value indicating the priority corresponding to the load. For example, a record in the first line indicates that the priority is increased by five in a case where the load of the search target is emergency relief supplies. For example, assume that emergency relief supplies are delivered by the mobile object 200 to a disaster-stricken area or the like at the time of disaster. Emergency relief supplies need to be delivered quickly. Therefore, in a case where the search target assumes the emergency relief supplies as the load, the priority calculation unit 1302 increases the priority. In this manner, the priority calculation unit 1302 calculates the priority according to the information indicating the load of the search target.

FIG. 8C is a diagram illustrating a third example of the rule information. In the example of FIG. 8C, items “insurance” and “priority” are set in the rule information. That is, the rule information includes information indicating the priority according to whether the owner has insurance. In this example, it is illustrated that the priority is increased by 3 when the user has insurance, and the priority is not increased when the user does not have insurance. In this manner, the priority calculation unit 1302 calculates the priority according to whether the owner of the search target has insurance.

The rule information may include a value indicating priority according to an attribute other than the above-described attribute. Furthermore, the calculation unit 130 may calculate the priority in consideration of a plurality of attributes. For example, the rule acquisition unit 1301 acquires the rule information of FIGS. 8A to 8C. Here, it is assumed that a mobile object of identification information “002” illustrated in FIG. 6 is a search target. In this case, since the load of the mobile object having the identification information “002” is food whose best-before date is November 18, the priority calculation unit 1302 increases the priority by 2. Furthermore, since the owner of the mobile object of the identification information “002” has insurance, the priority calculation unit 1302 increases the priority by 3. Then, when the latest position information of the mobile object of the identification information “002” indicates the place in the urban area, the priority calculation unit 1302 increases the priority by 3. That is, the priority calculation unit 1302 calculates the priority of the mobile object of the identification information “002” as 8.

Here, the content of the attribute and the value of the priority corresponding to the content are not limited to the examples of FIGS. 8A to 8C. For example, the priority may be higher when the load is a dangerous article than when the load is an emergency relief supplies. Furthermore, the rule information described with reference to FIGS. 8A to 8C is merely an example. In order to simplify the description, an example has been described in which the priority of the search target is calculated by adding the priority defined according to the attribute, but the rule information is not limited to this example. For example, the rule information may include a rule that a content of a specific attribute has a high priority regardless of other attributes. For example, it is assumed that there are one search target whose load is a dangerous article and another search target whose load is not a dangerous article. At this time, the priority calculation unit 1302 may set the priority of one search target higher than that of the other search targets regardless of the contents of the attributes of the other search targets.

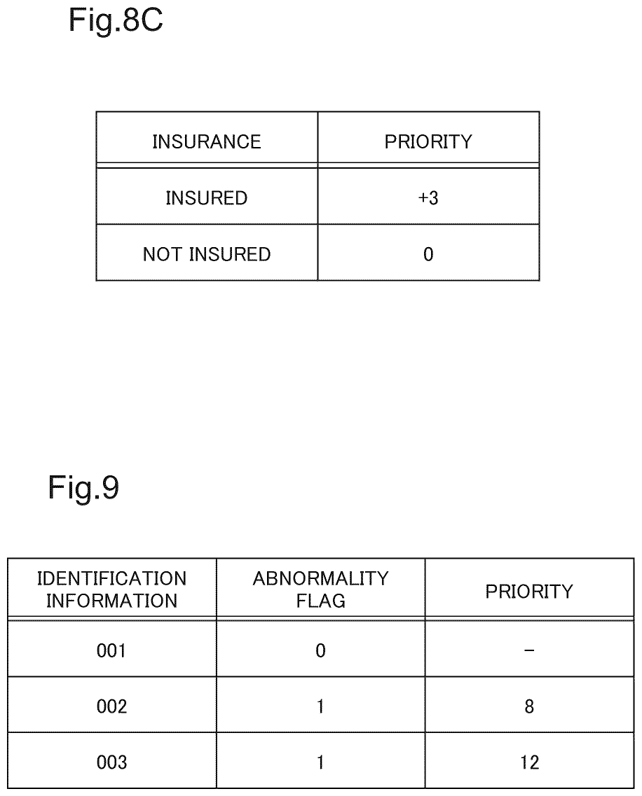

The setting unit 140 sets priority to the search target management information. The search target management information is information indicating a mobile object as a search target among the plurality of mobile objects 200. FIG. 9 is a diagram illustrating an example of search target management information. In the example of FIG. 9, items “identification information”, “abnormality flag”, and “priority” are set in the search target management information. The abnormality flag is information indicating whether the mobile object is a mobile object in which an abnormality has occurred, that is, whether the abnormality notification information has been transmitted. The abnormality flag is updated by the abnormality notification information acquisition unit 1102, for example, when the abnormality notification information acquisition unit 1102 acquires the abnormality notification information. The record in the first line indicates that the abnormality flag of the mobile object with the identification information “001” is “0”. This indicates that the mobile object of the identification information “001” is not transmitting the abnormality notification information, that is, is not a search target. The record in the second line indicates that the abnormality flag of the mobile object with the identification information “002” is “1”. This indicates that the mobile object of the identification information “002” has transmitted the abnormality notification information, that is, is a search target. The setting unit 140 sets, for example, a priority of 8 to the mobile object of the identification information “002”. The search target management information is output to, for example, a display of a terminal (not illustrated) that can communicate with the search assistance device 100. The user of the search assistance device 100 can grasp the priority via, for example, the terminal.

### First Operation Example of Search Assistance System 1000

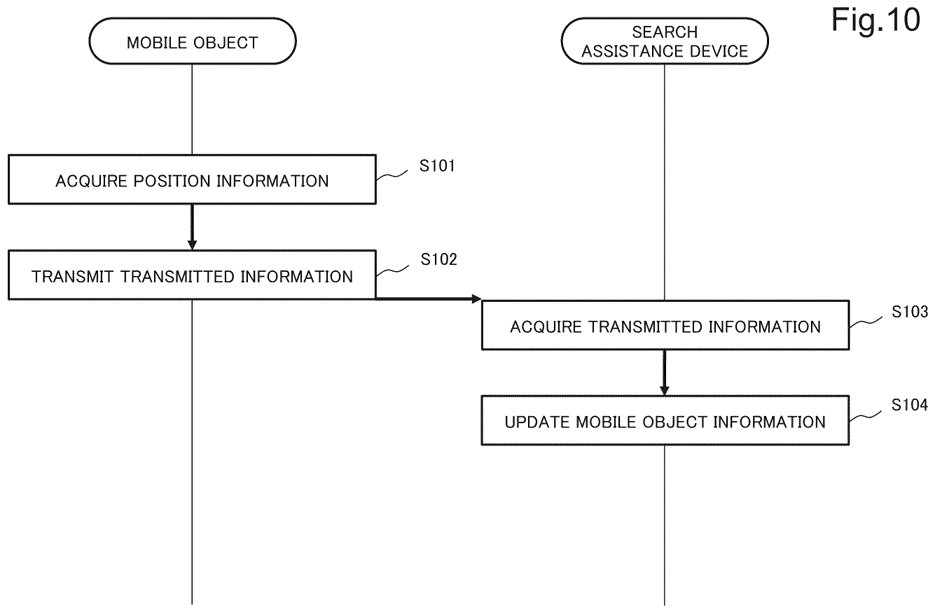

Next, an example of the operation of the search assistance system 1000 will be described with reference to FIG. 10. This operation example is an operation example when the search assistance device 100 acquires transmitted information. The process of the observation device 300 is omitted.

FIG. 10 is a sequence diagram illustrating an example of the operation of the search assistance system 1000. The position information acquisition unit 210 of the mobile object 200 acquires position information of the own machine (S101). The transmission unit 230 transmits transmitted information including the position information and the identification information (S102). The transmitted information acquisition unit 1101 of the search assistance device 100 acquires transmitted information via the observation device 300 (S103). Then, the transmitted information acquisition unit 1101 updates the mobile object information based on the acquired transmitted information (S104). Specifically, the transmitted information acquisition unit 1101 specifies the same identification information as the identification information included in the transmitted information from the mobile object information. Then, the transmitted information acquisition unit 1101 updates the position information associated with the specified identification information in such a way as to indicate the position information included in the transmitted information.

This operation example may be repeatedly performed as needed. For example, this operation example may be performed each time the mobile object 200 acquires the position information.

### Second Operation Example of Search Assistance System 1000

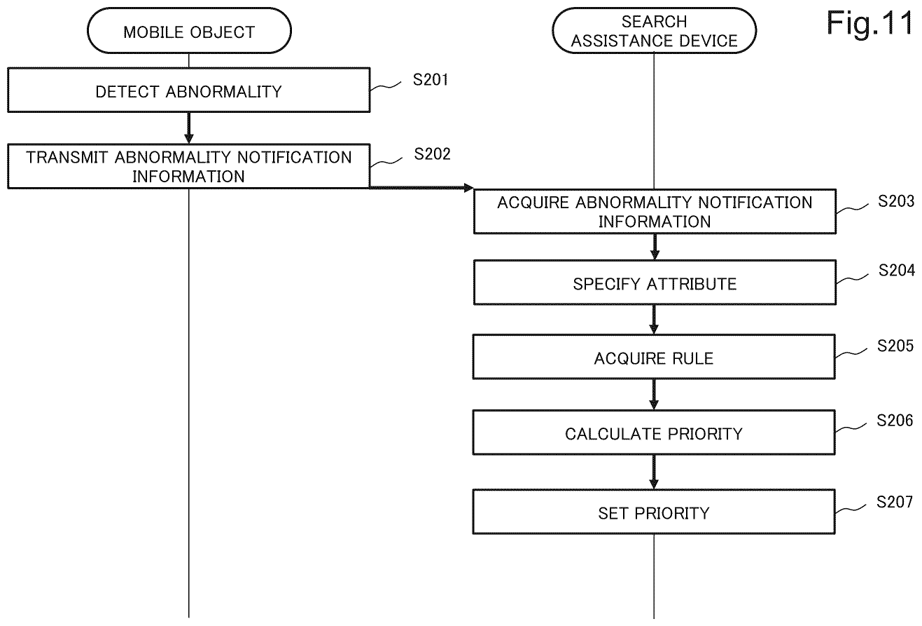

Next, another example of the operation of the search assistance system 1000 will be described with reference to FIG. 11. This operation example is an operation example when the search assistance device 100 acquires abnormality notification information. The process of the observation device 300 is omitted.

FIG. 11 is a sequence diagram illustrating another example of the operation of the search assistance system 1000. The abnormality detection unit 220 of the mobile object 200 detects an abnormality (S201). The transmission unit 230 transmits abnormality notification information (S202).

The abnormality notification information acquisition unit 1102 acquires the abnormality notification information via the observation device 300 (S203). The specification unit 120 specifies the attribute of the mobile object (i.e., search target) that transmitted the abnormality notification information (S204). For example, the specification unit 120 specifies the attribute of the search target from the mobile object information based on the identification information included in the abnormality notification information. The rule acquisition unit 1301 acquires rule information from the storage device 190 (S205). The priority calculation unit 1302 calculates the priority of the search target (S206). Specifically, the priority calculation unit 1302 calculates the priority corresponding to the specified attribute of the search target based on the rule information. Then, the setting unit 140 sets a priority according to the search target in the search target management information (S207).

As described above, the search assistance device 100 according to the second example embodiment acquires the abnormality notification information transmitted from the mobile object in which the abnormality has occurred among the plurality of mobile objects. In addition, the search assistance device 100 specifies the attribute of the search target that is the mobile object that transmitted the abnormality notification information based on the attribute information regarding the attribute of the mobile object stored in the storage means. Then, the search assistance device 100 calculates a priority of the search corresponding to the attribute of the search target based on a predetermined rule defined in advance. As a result, for example, in a case where an abnormality has occurred in a plurality of mobile objects, the search assistance device 100 can present which mobile object should be preferentially searched for by providing priority of the search to the observer (e.g., administrator of corridor) of the mobile object. Therefore, the observer of the mobile object can quickly start searching for the mobile object based on the priority. That is, the search assistance device 100 according to the second example embodiment can assist a search for a mobile object.

In addition, in the second example embodiment, the attribute information may include at least one of position information when the search target transmits abnormality notification information, information indicating a load of the search target, and information indicating whether the owner of the search target has insurance. Then, the search assistance device 100 may calculate the priority according to the position information, the information indicating the load of the search target, whether the owner of the search target has insurance, and the like. As described above, the search assistance device 100 can calculate priorities according to various attributes.

In addition, the search assistance system 1000 according to the second example embodiment includes a mobile object and a search assistance device. The mobile object acquires position information, detects an abnormality, and transmits abnormality notification information when the abnormality is detected. As a result, the search assistance system 1000 can specify the mobile object in which the abnormality is detected.

### First Modified Example

The position information may be acquired by a method not using the GNSS. For example, the position information acquisition unit 210 of the mobile object 200 may receive a signal transmitted from the observation device 300 installed on the ground and acquire position information indicating the position of the own machine based on the received signal.

For example, as illustrated in FIG. 4, it is assumed that the mobile object 200 passes through a corridor formed above a river. In this case, the position information acquisition unit 210 of the mobile object 200 receives signals from the plurality of observation devices 300 installed on both banks of the river. Then, the position information acquisition unit 210 calculates the position information of the own machine using the principle of triangulation.

### Third Example Embodiment

Next, a search assistance system 1001 according to a third example embodiment will be described. In a third example embodiment, an example in which a mobile object performs capturing will be described. Description of contents redundant with the contents described in the first and second example embodiment will be partially omitted.

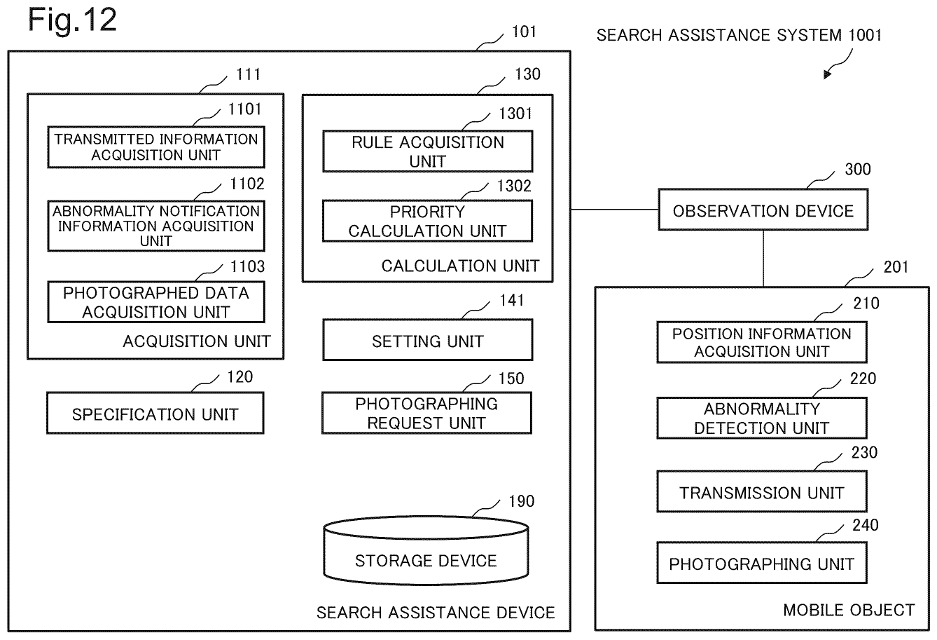

FIG. 12 is a block diagram illustrating an example of a functional configuration of the search assistance system 1001. As illustrated in FIG. 11, the search assistance system 1001 includes a search assistance device 101, a mobile object 201, and an observation device 300.

### [Details of Mobile Object 201]

The mobile object 201 is a mobile object similar to the mobile object 200 described in the first and second example embodiments. That is, there may be a plurality of mobile objects 201. The mobile object 201 may perform the following processes in addition to the process of the mobile object 200.

The mobile object 201 includes a position information acquisition unit 210, an abnormality detection unit 220, a transmission unit 230, and a capturing unit 240. The capturing unit 240 performs capturing. For example, the capturing unit 240 captures the periphery of the mobile object 200 while the mobile object 200 is flying. In addition, the capturing unit 240 may perform capturing in response to a request from the search assistance device 101 described later.

The transmission unit 230 transmits captured data that is data corresponding to the image captured by the capturing unit 240. The captured data includes identification information. Furthermore, the captured data may include time and position information at the time of capturing by the capturing unit 240.

### [Details of Search Assistance Device 101]

The search assistance device 101 may perform the following processes in addition to the processes of the search assistance device 100 described in the first and second example embodiments.

The search assistance device 101 includes an acquisition unit 111, a specification unit 120, a calculation unit 130, a setting unit 140, and a capturing request unit 150. Furthermore, the search assistance device 101 may include a storage device 190.

The capturing request unit 150 requests capturing the one or more mobile objects 201. Specifically, the capturing request unit 150 requests the mobile object 201 flying around the search target to capture the surroundings. For example, the capturing request unit 150 acquires position information of a search target. Then, the capturing request unit 150 specifies a mobile object whose current position is within a predetermined distance from the search target based on the position information of the mobile object included in the mobile object information. The mobile object specified at this time is a mobile object different from the search target. Whether the mobile object is the search target is grasped by the abnormality flag of the search target management information. The capturing request unit 150 transmits a capturing request indicating that capturing is requested to the specified mobile object. The capturing request is transmitted to the specified mobile object via the observation device 300.

The acquisition unit 111 includes a transmitted information acquisition unit 1101, an abnormality notification information acquisition unit 1102, and captured data acquisition unit 1103. The captured data acquisition unit 1103 acquires the captured data transmitted from the mobile object 201. At this time, the captured data acquisition unit 1103 may sequentially acquire the captured data from the mobile object 200. The captured data acquisition unit 1103 stores the captured data in the storage device 190.

The setting unit 141 may associate the captured data with the search target management information. For example, assume that a mobile object 201-1 is a search target. Then, assume that a mobile object 200-2 is flying near the mobile object 201-1. In this case, the captured data acquisition unit 1103 acquires the captured data from the mobile object 200-2. Then, the setting unit 141 associates the captured data acquired from the mobile object 201-2 with the identification information of the mobile object 201-1. That is, the setting unit 141 associates the captured data acquired from the mobile object 201 that is not the search target with the identification information of the search target.

### Operation Example of Search Assistance System 1001

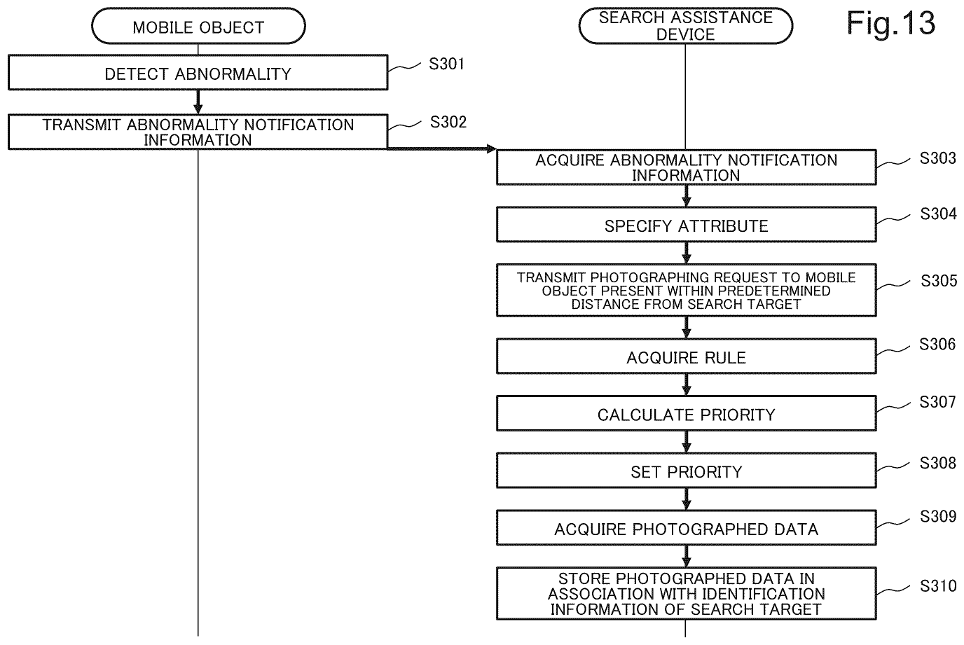

Next, an operation example of the search assistance system 1001 will be described with reference to FIG. 13. This operation example is an operation example when the search assistance device 101 that has acquired abnormality notification information transmits a capturing request. The process of the observation device 300 is omitted.

Since the processes of S301 to S304 are similar to the processes of S201 to S204 of FIG. 11, description thereof is omitted. The capturing request unit 150 transmits a capturing request to a mobile object present within a predetermined distance from a search target (S305). For example, the capturing request unit 150 calculates a distance between the latest position information of the search target and the latest position information of the mobile object included in the mobile object information. The capturing request unit 150 transmits the capturing request to the mobile object in which the distance is within a predetermined value.

Since the processes of S306 to S308 are similar to the processes of S205 to S207 of FIG. 11, description thereof is omitted. The captured data acquisition unit 1103 acquires the captured data (S309). Then, the setting unit 141 stores the acquired captured data in association with the identification information of the search target (S310).

As described above, the search assistance device 101 according to the third example embodiment may transmit a capturing request to a mobile object present within a predetermined distance from a search target. Then, the search assistance device 101 acquires the captured data generated in response to the capturing request from the mobile object present within a predetermined distance. As a result, the search assistance device 101 can provide captured data obtained in which the periphery of the search target is captured. That is, the search assistance device 101 can assist a search for a mobile object.

### Second Modified Example

In the above example embodiment, an example in which the mobile object 201 performs capturing in response to the reception of the capturing request has been described. The mobile object 201 may constantly perform capturing. For example, the capturing unit 240 performs capturing while the mobile object 201 is flying. The transmission unit 230 transmits the captured data as needed. At this time, the captured data includes position information and capturing time. The captured data acquisition unit 1103 stores the acquired captured data in the storage device 190. The setting unit 141 specifies the captured data that is within a predetermined distance from the search target and captured within a predetermined time from the time when the abnormality notification information is transmitted. Then, the setting unit 141 associates the specified captured data with the identification information of the search target.

### Third Modified Example

The search assistance device 101 may give value data, to be described later, to the owner of the mobile object that transmitted the captured data.

For example, the capturing request unit 150 transmits a capturing request to the mobile object 200 different from the search target. The captured data acquisition unit 1103 then acquires the captured data from the mobile object 200 to which the capturing request has been transmitted. In this manner, the setting unit 141 adds the value data to the owner of the mobile object 200 that has transmitted the captured data in response to the capturing request.

The value data is data indicating economic value. The value data is, for example, data indicating money, but is not limited to this example. The value data may be data indicating a value similar to money, exchangeable for goods or services. For example, the value data may be points, electronic money, encrypted assets, electronic coupons, and the like. The setting unit 141 further associates value data with, for example, owner information in which identification information of an owner, an owner's name, a contact, and the like are associated.

### Fourth Example Embodiment

Next, a search assistance system 1002 according to a fourth example embodiment will be described. In a fourth example embodiment, an example of determining a search range will be described. Description of contents redundant with the contents described in the first, second and third example embodiment will be partially omitted.

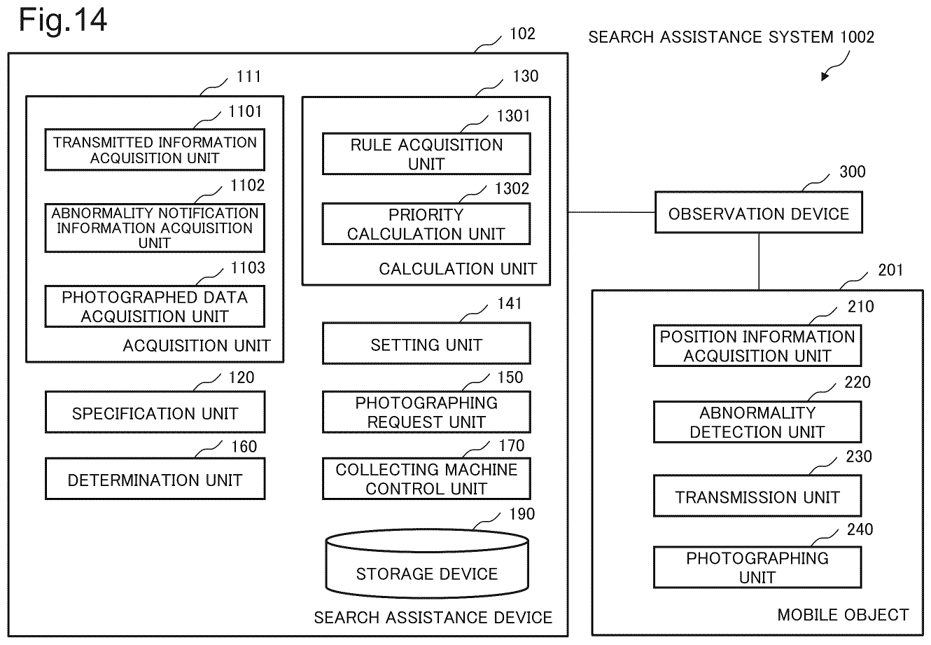

FIG. 14 is a block diagram illustrating an example of a functional configuration of the search assistance system 1002. As illustrated in FIG. 14, the search assistance system 1002 includes a search assistance device 102, a mobile object 201, and an observation device 300.

### [Details of Search Assistance Device 102]

The search assistance device 102 may perform the following processes in addition to the process of the search assistance device 100 described in the first and second example embodiments or the process of the search assistance device 101 described in the third example embodiment.

The search assistance device 102 includes an acquisition unit 111, a specification unit 120, a calculation unit 130, a setting unit 140, a capturing request unit 150, a determination unit 160, and a collecting machine control unit 170. Furthermore, the search assistance device 102 may include a storage device 190.

The determination unit 160 determines a search range. The determination unit 160 is an example of a determination means. For example, the determination unit 160 sets a range including the position information included in the mobile object information as the search range. That is, the determination unit 160 sets a range including the latest position information of the search target as the search range. The determination unit 160 stores the identification information of the mobile object 201 and the information indicating the search range in the storage device 190 in association with each other.

The collecting machine control unit 170 controls a collecting machine (not illustrated). The collecting machine is a mobile object that collects a search target. The collecting machine collects a search target by an automatic operation or an operation of a user of the collecting machine using, for example, a capturing arm or a net included in the collecting machine. The collecting machine control unit 170 at least controls the collecting machine to move to the search range.

In addition, the collecting machine control unit 170 controls the collecting machine based on the priority. For example, assume that the mobile object 201-1 and the mobile object 201-2 are search targets. In addition, assume that the priority of the mobile object 201-1 is 5 and the priority of the mobile object 201-2 is 10. In this case, the collecting machine control unit 170 controls the collecting machine to move to the search range corresponding to the mobile object 201-2 with high priority. In this manner, the collecting machine control unit 170 controls the collecting machine to move to the search range of the search target having the highest priority among the plurality of search targets.

### Operation Example of Search Assistance System 1002

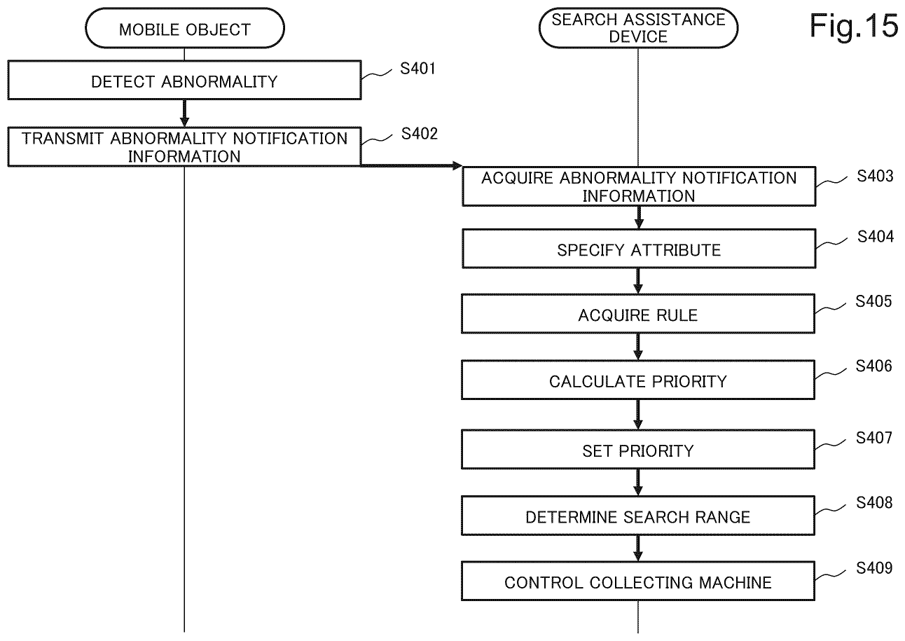

Next, an operation example of the search assistance system 1002 will be described with reference to FIG. 15. This operation example is an operation example when the search assistance device 102 that has acquired the abnormality notification information determines a search range. In addition, the process of the observation device 300 is omitted.

Since the processes of S401 to S407 are similar to the processes of S201 to S207 of FIG. 11, description thereof is omitted. The determination unit 408 determines a search range of a search target (S408). The collecting machine control unit 170 controls a collecting machine (S409). For example, the collecting machine control unit 170 moves the collecting machine to a search range of a search target with high priority among the plurality of search targets.

In the present operation example, the process related to the transmission of the capturing request, the acquisition of the captured data, and the like described in FIG. 13 is omitted. However, the process related to the transmission of the capturing request, the acquisition of the captured data, and the like described in FIG. 13 may be performed in the present operation example.

As described above, the search assistance device 102 according to the fourth example embodiment determines the latest position information of the search target as the search range of the search target. Then, the search assistance device 102 moves the collecting machine to a search range corresponding to a search target with high priority among the plurality of search targets. As a result, the search assistance device 102 can search for the search targets in descending order of priority among the plurality of search targets.

### Fourth Modified Example

In a case where an abnormality occurs and the mobile object falls, there is a possibility that the mobile object cannot transmit transmitted information. That is, there is a case where the position information of the search target is not updated after the search target transmits the abnormality notification information. In this case, the determination unit 160 may estimate the search range.

For example, the determination unit 160 specifies position information when the search target transmits abnormality notification information from the mobile object information. Then, the determination unit 160 acquires information regarding terrain corresponding to the specified position information. The information regarding the terrain is map information including information on altitude and inclination. For example, in a case where the search target falls on an inclined place such as a slope of a mountain or a hill, the search target may roll along the inclination. In addition, for example, in a case where a search target falls into a river, there is a possibility that the search target is carried away by the river. As described above, the search target may move due to the terrain of the place where the search target has fallen. The determination unit 160 estimates a range in which the search target moves due to the terrain from the specified position information based on the information regarding the terrain. Then, the determination unit 160 determines a range in which the search target moves due to the terrain as a search range.

As described above, the search assistance device 102 may determine the search range of the search target based on the position information when the search target transmits the abnormality notification information and the information regarding the terrain corresponding to the position information. As a result, even in a case where the search target does not transmit the transmitted information including the position information after transmitting the abnormality notification information, the search assistance device 102 can provide the search range.

### Fifth Example Embodiment

Next, a search assistance system 1003 according to a fifth example embodiment will be described. In the fifth example embodiment, processing of a mobile object in a case where an abnormality is detected will be described. Description of contents redundant with the contents described in the first, second, third and fourth example embodiment will be partially omitted.

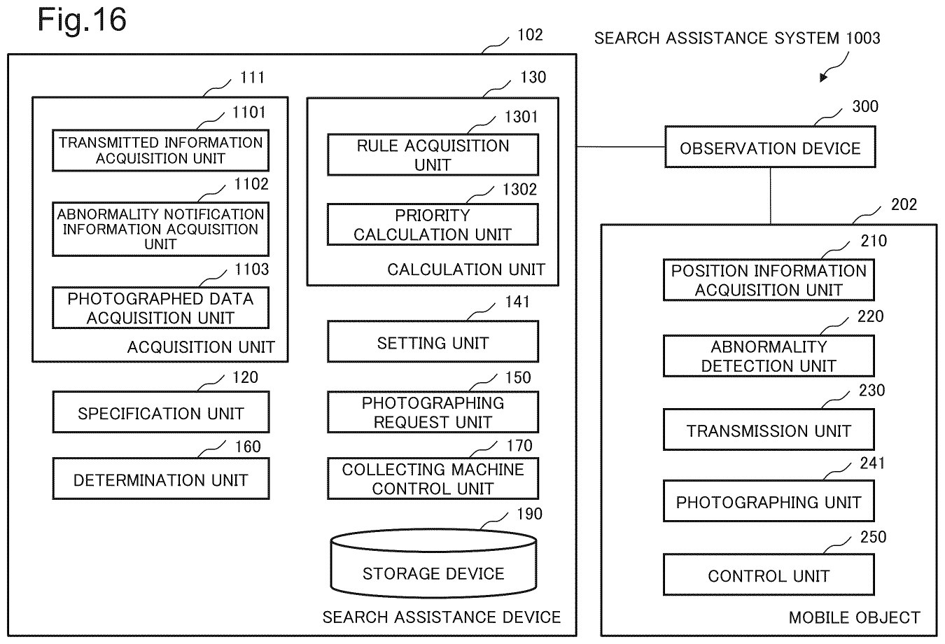

FIG. 16 is a block diagram illustrating an example of a functional configuration of the search assistance system 1003. As illustrated in FIG. 16, the search assistance system 1003 includes a search assistance device 102, a mobile object 202, and an observation device 300. The search assistance system 1003 may include a search assistance device 100 or a search assistance device 101 instead of the search assistance device 102.

### [Details of Mobile Object 202]

The mobile object 202 may perform the following processes in addition to the process of the search assistance device 100 described in the first and second example embodiments or the process of the search assistance device 101 described in the third example embodiment.

The mobile object 202 includes a position information acquisition unit 210, an abnormality detection unit 220, a transmission unit 230, a capturing unit 241, and a control unit 250.

The capturing unit 241 may perform capturing when an abnormality is detected. For example, the capturing unit 241 starts capturing when the abnormality is detected by the abnormality detection unit 220.

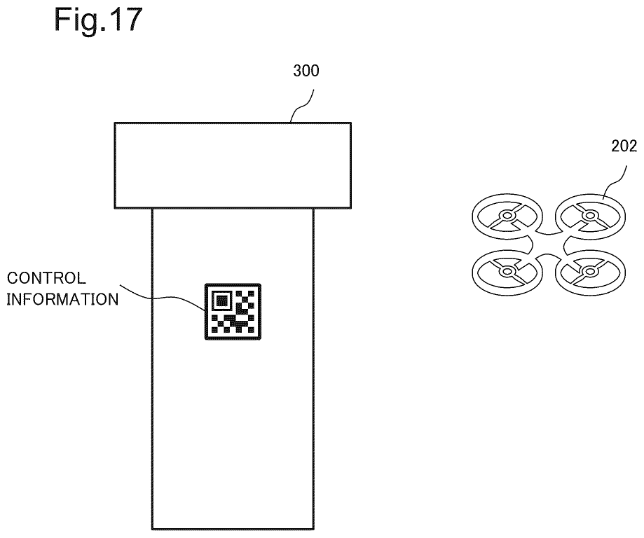

The control unit 250 controls the own machine based on the captured data. Specifically, the control unit 250 reads the control information from the image captured by the capturing unit 241. Here, the control information is information that can be read by the mobile object 202 and is information for controlling the mobile object 202. FIG. 17 is a diagram illustrating an example of a situation in which the mobile object 202 reads the control information. In the example of FIG. 17, the control information is attached to the observation device 300. Here, it is assumed that an abnormality is detected in the mobile object 202. In this case, the capturing unit 241 of the mobile object 202 starts capturing. The periphery of the mobile object 202 appears in the captured image. When the control information appears in the captured image, the control unit 250 reads the control information. Then, the control unit 250 controls the own machine based on the read control information. For example, the control unit 250 approaches the place where the read control information is attached and causes the vehicle to land.

The control information may be a two-dimensional code or a one-dimensional code in which various types of information are recorded. In this case, the control information may include information indicating a point. The control unit 250 may read the control information to control the own machine to land at a point included in the control information. Furthermore, the control information is not limited to this example, and may be a symbol, a mark, or the like. In this case, the control unit 250 may approach the read control information and cause the own machine to land. Furthermore, the control information may not be attached to the observation device 300. For example, the control information may be attached or drawn at a possible landing location. For example, in a case where the control information exists on the ground, the control unit 250 may control the own machine to land on the read control information.

In this manner, the control unit 250 reads the control information included in the image captured by the capturing unit 241, and causes the own machine to land based on the control information. The control unit 250 is an example of a control means.

### Operation Example of Search Assistance System 1003

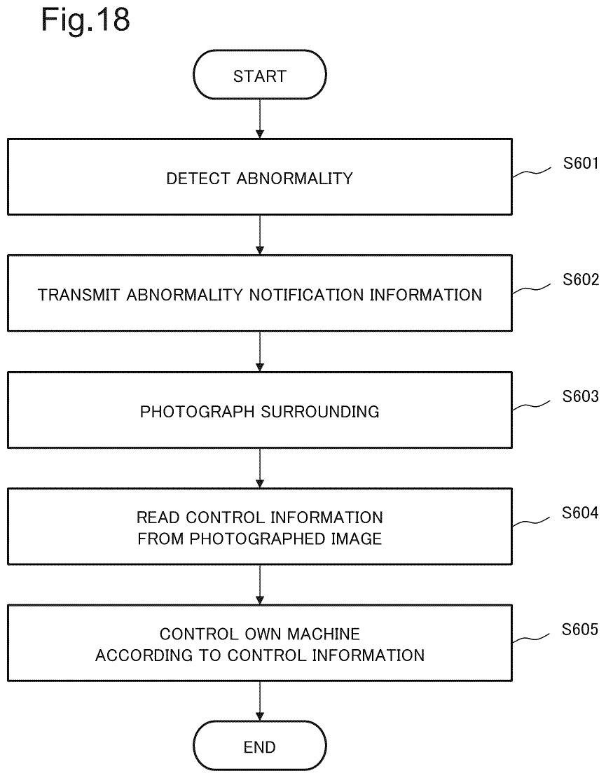

Next, an operation example of the search assistance system 1003 will be described with reference to FIG. 18. This operation example is an operation example of the mobile object 202 in which the abnormality is detected.

FIG. 18 is a flowchart illustrating an example of the operation of the mobile object. The abnormality detection unit 220 detects an abnormality (S601). Then, the transmission unit 230 transmits abnormality notification information (S602). The capturing unit 241 captures the surroundings (S603). The control unit 250 reads the control information from the captured image (S604). The control unit 250 controls the own machine according to the read control information (S605). For example, the control unit 250 approaches the read control information and causes the own machine to land.

As described above, in a case where an abnormality is detected, the search assistance system 1003 according to the fifth example embodiment starts capturing, reads the control information included in the image captured by the capturing means, and causes the own machine to land based on the control information. As a result, the search assistance system 1003 can land the mobile object in which the abnormality has occurred on a specific place. Therefore, the search assistance system 1003 can facilitate the search for a mobile object in which an abnormality has occurred.

### Configuration Example of Hardware of Search Assistance System

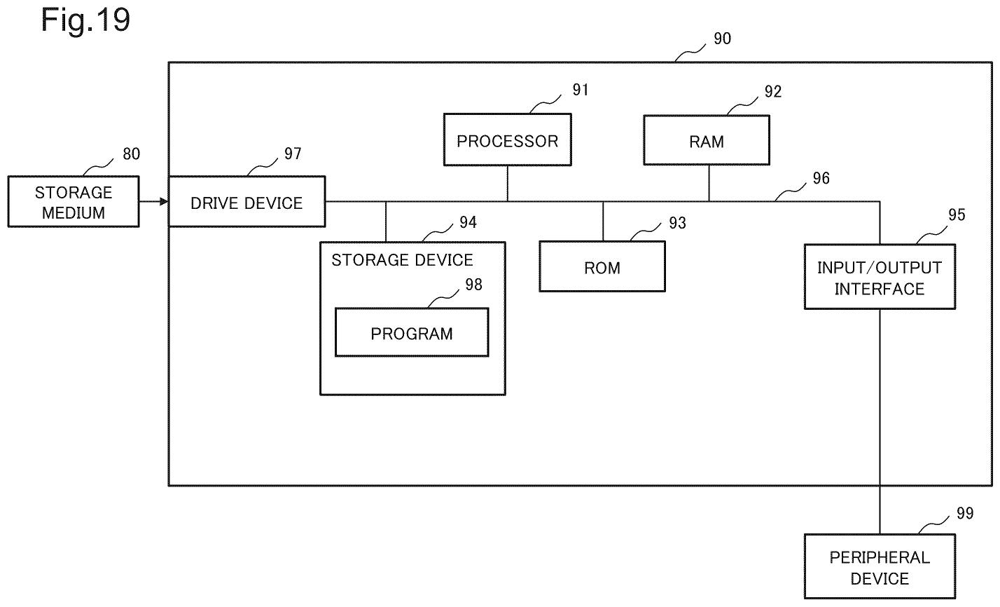

Hardware constituting the search assistance device or the mobile object according to the first, second, third, fourth, and fifth example embodiments described above will be described. FIG. 19 is a block diagram illustrating an example of a hardware configuration of a computer device that implements the search assistance system according to each example embodiment. In the computer device 90, the search assistance device, the mobile object, and the search assistance method described in each example embodiment and each modified example are achieved.

As illustrated in FIG. 19, the computer device 90 includes a processor 91, a random access memory (RAM) 92, a read only memory (ROM) 93, a storage device 94, an input/output interface 95, a bus 96, and a drive device 97. The search assistance device and the mobile object may be achieved by a plurality of electric circuits.

The storage device 94 stores a program (computer program) 98. The processor 91 executes the program 98 of the search assistance device using the RAM 92. Specifically, for example, the program 98 includes a program that causes a computer to execute the process illustrated in FIGS. 3, 10, 11, 13, 15, and 18. The functions of the components of the search assistance device and the mobile object are implemented in response to the processor 91 executing the program 98. The program 98 may be stored in the ROM 93. In addition, the program 98 may be recorded in the storage medium 80 and read using the drive device 97, or may be transmitted from an external device (not illustrated) to the computer device 90 via a network (not illustrated).

The input/output interface 95 exchanges data with a peripheral device (keyboard, mouse, display device, etc.) 99. The input/output interface 95 functions as a means for acquiring or outputting data. The bus 96 connects the components.

There are various modified examples for the search assistance device and the method of achieving the mobile object. For example, the search assistance device can be implemented as a dedicated device. In addition, the search assistance device can be achieved based on a combination of a plurality of devices.

Processing methods for causing a storage medium to record a program for achieving each component in a function of each example embodiment, reading the program recorded in the storage medium as a code, and executing the program in a computer are also included in the scope of each example embodiment. That is, a computer-readable storage medium is also included in the scope of each example embodiment. In addition, a storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. In addition, the program recorded in the storage medium is not limited to a program that executes the process alone, and programs that operate on an operating system (OS) to execute process in cooperation with other software and functions of an extension board are also included in the scope of each example embodiment.

Although the present invention has been described with reference to the example embodiments, the present invention is not limited to the above example embodiments. Various changes that can be understood by those skilled in the art can be made to the configuration and details of the present invention within the scope of the present invention.

The above example embodiments and modified examples can be appropriately combined.

Some or all of the above example embodiments may be described as the following supplementary notes, but are not limited to the following.

### Supplementary Note

### [Supplementary Note 1]

A search assistance device comprising:
an acquisition means configured to acquire abnormality notification information transmitted from a mobile object in which an abnormality has occurred among a plurality of mobile objects;
a specification means configured to specify an attribute of a search target, which is a mobile object that has transmitted the abnormality notification information, based on attribute information related to attributes of mobile objects stored in a storage means; and
a calculation means configured to calculate a priority of a search according to the attribute of the search target based on a predetermined rule defined in advance.

### [Supplementary Note 2]

The search assistance device according to supplementary note 1, wherein
the attribute information includes position information when the search target transmits the abnormality notification information, and
the calculation means calculates the priority according to the position information.

### [Supplementary Note 3]

The search assistance device according to supplementary note 1 or 2, wherein
the attribute information includes information indicating a load of the search target, and
the calculation means calculates the priority according to information indicating a load of the search target.

### [Supplementary Note 4]

The search assistance device according to any one of supplementary notes 1 to 3, wherein
the attribute information includes information indicating whether an owner of the search target has insurance, and
the calculation means calculates the priority according to whether the owner of the search target has the insurance.

### [Supplementary Note 5]

The search assistance device according to any one of supplementary notes 1 to 4, further comprising:
a capturing request means configured to transmit a capturing request to a mobile object present within a predetermined distance from the search target, wherein
the acquisition means acquires captured data generated in response to the capturing request from a mobile object present within the predetermined distance.

### [Supplementary Note 6]

The search assistance device according to supplementary note 5, further comprising:
a setting means configured to give value data to an owner of a mobile object present within the predetermined distance when the acquisition means acquires the captured data.

### [Supplementary Note 7]

The search assistance device according to any one of supplementary notes 1 to 6, further comprising:
a determination means configured to determine a search range of the search target based on position information when the search target has transmitted the abnormality notification information and information regarding a terrain corresponding to the position information.

### [Supplementary Note 8]

A search assistance system comprising:
a mobile object including,
   a position information acquisition means configured to acquire position information,
   an abnormality detection means configured to detect abnormality, and
   a transmission means configured to transmit abnormality notification information when the abnormality is detected; and
a search assistance device including,
   an acquisition means configured to acquire the abnormality notification information transmitted from the mobile object in which the abnormality has occurred among the plurality of mobile objects,
   a specification means configured to specify an attribute of a search target that has transmitted the abnormality notification information of the mobile objects based on attribute information related to attributes of the mobile objects stored in a storage means, and
   a calculation means configured to calculate a priority of a search according to the attribute of the search target based on a predetermined rule defined in advance.

### [Supplementary Note 9]

The search assistance system according to supplementary note 8, wherein
the mobile object includes:
a capturing means and a control means,
the capturing means starts capturing in a case where the abnormality is detected, and
the control means reads control information included in an image captured by the capturing means, and causes the own machine to land based on the control information.

### [Supplementary Note 10]

A search assistance method comprising:
acquiring abnormality notification information transmitted from a mobile object in which an abnormality has occurred among a plurality of mobile objects;
specifying an attribute of a search target, which is a mobile object that has transmitted the abnormality notification information, based on attribute information related to attributes of mobile objects stored in a storage means; and
calculating a priority of a search according to the attribute of the search target based on a predetermined rule defined in advance.

### [Supplementary Note 11]

A computer-readable storage medium storing a program for causing a computer to execute:
a process of acquiring abnormality notification information transmitted from a mobile object in which an abnormality has occurred among a plurality of mobile objects;
a process of specifying an attribute of a search target, which is a mobile object that has transmitted the abnormality notification information, based on attribute information related to attributes of mobile objects stored in a storage means; and
a process of calculating a priority of a search according to the attribute of the search target based on a predetermined rule defined in advance.

### REFERENCE SIGNS LIST

100, 101, 102 search assistance device
110, 111 acquisition unit
120 specification unit
130 calculation unit
140, 141 setting unit
150 capturing request unit
160 determination unit
170 collecting machine control unit
200, 201, 202 mobile object
210 position information acquisition unit
220 abnormality detection unit
230 transmission unit
240, 241 capturing unit
250 control unit
1000, 1001, 1002, 1003 search assistance system

What is claimed is:

1. A search assistance device comprising:
a memory configured to store instructions; and
at least one processor configured to execute the instructions to perform:
acquiring abnormality notification information transmitted from a mobile object in which an abnormality has occurred among a plurality of mobile objects;
specifying an attribute of a search target, which is a mobile object that has transmitted the abnormality notification information, based on attribute information related to attributes of mobile objects stored in a storage-means; and
calculating a priority of a search according to the attribute of the search target based on a predetermined rule defined in advance.

2. The search assistance device according to claim 1, wherein
the attribute information includes position information when the search target transmits the abnormality notification information, and
the at least one processor is configured to execute the instructions to perform:
calculating the priority according to the position information.

3. The search assistance device according to claim 1, wherein
the attribute information includes information indicating a load of the search target, and
the at least one processor is configured to execute the instructions to perform:
calculating the priority according to information indicating a load of the search target.

4. The search assistance device according to claim 1, wherein
the attribute information includes information indicating whether an owner of the search target has insurance, and
the at least one processor is configured to execute the instructions to perform:
calculating the priority according to whether the owner of the search target has insurance.

5. The search assistance device according to claim 1,
wherein
the at least one processor is further configured to execute the instructions to perform:
transmitting a capturing request to a mobile object present within a predetermined distance from the search target, and
acquiring captured data generated in response to the capturing request from a mobile object present within the predetermined distance.

6. The search assistance device according to claim 5, wherein
the at least one processor is further configured to execute the instructions to perform:
giving value data to an owner of a mobile object present within the predetermined distance when acquiring the captured data.

7. The search assistance device according to claim 1,
wherein
the at least one processor is further configured to execute the instructions to perform:
determining a search range of the search target based on position information when the search target has transmitted the abnormality notification information and information regarding a terrain corresponding to the position information.

8-9. (canceled)

10. A search assistance method comprising:
acquiring abnormality notification information transmitted from a mobile object in which an abnormality has occurred among a plurality of mobile objects;
specifying an attribute of a search target, which is a mobile object that has transmitted the abnormality notification information, based on attribute information related to attributes of mobile objects stored in a storage; and
calculating a priority of a search according to the attribute of the search target based on a predetermined rule defined in advance.

11. A non-transitory computer-readable storage medium storing a program for causing a computer to execute:
a process of acquiring abnormality notification information transmitted from a mobile object in which an abnormality has occurred among a plurality of mobile objects;
a process of specifying an attribute of a search target, which is a mobile object that has transmitted the abnormality notification information, based on attribute information related to attributes of mobile objects stored in a storage-means; and
a process of calculating a priority of a search according to the attribute of the search target based on a predetermined rule defined in advance.
